(19) United States
(12) Patent Application Publication
(10) Pub. No.: US 2005/0186116 A1
(43) Pub. Date: Aug. 25, 2005

(54) Sensor for sensing a chemical component concentration using an electroactive material

(75) Inventor: Michael A. Centanni, Parma, OH (US)

Correspondence Address: KUSNER & JAFFE;HIGHLAND PLACE SUITE 310, 6151 WILSON MILLS ROAD, HIGHLAND HEIGHTS, OH, 44143, US

(73) Assignee: STERIS Inc.

(21) Appl. No.: 11/116,574

(22) Filed: Apr. 28, 2005

Related U.S. Application Data
(62) Division of application No. 10/608,276, filed on Jun. 27, 2003.

(51) Int. Cl. B32B 5/02; G01N 27/00; B32B 27/04

(52) U.S. Cl. 422/82.01

(57) ABSTRACT

An electroactive material (e.g., a doped electroactive polymer, or an intercalcated carbon/graphite fiber) responsive to the concentration of a chemical component is used to sense the concentration of the chemical component inside a chamber. The conductivity, or other electrical property of the electroactive material, varies in response to the exposure to the chemical component.

### RELATED APPLICATIONS

This application is a divisional of co-pending U.S. patent application Ser. No. 10/608,276, filed Jun. 27, 2003, entitled “Sensor for Sensing a Chemical Component Concentration using an Electroactive Material.”

### FIELD OF THE INVENTION

The present invention relates to a method and apparatus for sensing concentration of a chemical used in a biocontamination deactivation process, and more particularly relates to a method and apparatus for sensing chemical component concentrations using materials having electroactive properties.

### BACKGROUND OF THE INVENTION

It has been recognized that there exists conductive materials that respond to the presence of certain chemicals with a change in at least one electrical property thereof. Such materials are known as “electroactive materials.” The present invention utilizes such materials to provide a method and apparatus for sensing the concentration of a chemical component used in a biocontamination deactivation process.

### SUMMARY OF THE INVENTION

In accordance with the present invention, there is provided an apparatus for sensing a concentration of vaporized hydrogen peroxide, comprising: (a) a sensing element comprised of an electroactive material, wherein said sensing element is exposed to vaporized hydrogen peroxide inside a chamber; and (b) means for determining a change in an electrical property of the electroactive material, wherein said change in the electrical property varies in accordance with a change in the concentration of the vaporized hydrogen peroxide in the chamber.

In accordance with another aspect of the present invention, there is provided a method for sensing a concentration of vaporized hydrogen peroxide, the method comprising: (a) exposing a sensing element to vaporized hydrogen peroxide inside a chamber, wherein said sensing element includes an electroactive material; and (b) determining a change in an electrical property of the electroactive material, wherein said change in the electrical property varies in accordance with a change in the concentration of the vaporized hydrogen peroxide in the chamber.

In accordance with another aspect of the present invention, there is provided a sensor for the detection of a concentration of a chemical component, comprising: (a) a host material; (b) an additive that modifies an electrical property of the host material, the additive having a chemical reaction when exposed to the chemical component; (c) a source of electrical current, said electrical current conducting through the host material; and (d) means for measuring a change in the electrical property of the host material as the chemical component reacts with the additive.

In accordance with yet another aspect of the present invention, there is provided a method for sensing a concentration of a chemical component in a chamber, the method comprising: (a) exposing a sensing element to the chemical component inside the chamber, wherein said sensing element includes an electroactive material; (b) determining a change in an electrical property of the electroactive material, wherein said change in the electrical property varies in accordance with a change in the concentration of the chemical component in the chamber; and (c) storing a plurality of data sets in a memory, wherein said data sets include a value indicative of said electrical property as a function of time exposure to the chemical component.

An advantage of the present invention is the provision of a method and apparatus for sensing a chemical concentration using materials having electroactive properties.

Another advantage of the present invention is the provision of a method and apparatus for sensing a chemical concentration by measuring the electrical properties of a material.

These and other advantages will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a block diagram of a contamination deactivating system including a chemical concentration sensing element, according to a preferred embodiment of the present invention;

FIG. 2 is a schematic diagram illustrating a sensor circuit, according to a first embodiment; and

FIG. 3 is a schematic diagram illustrating a sensor circuit, according to a second embodiment.

### DETAILED DESCRIPTION OF A PREFERRED EMBODIMENT

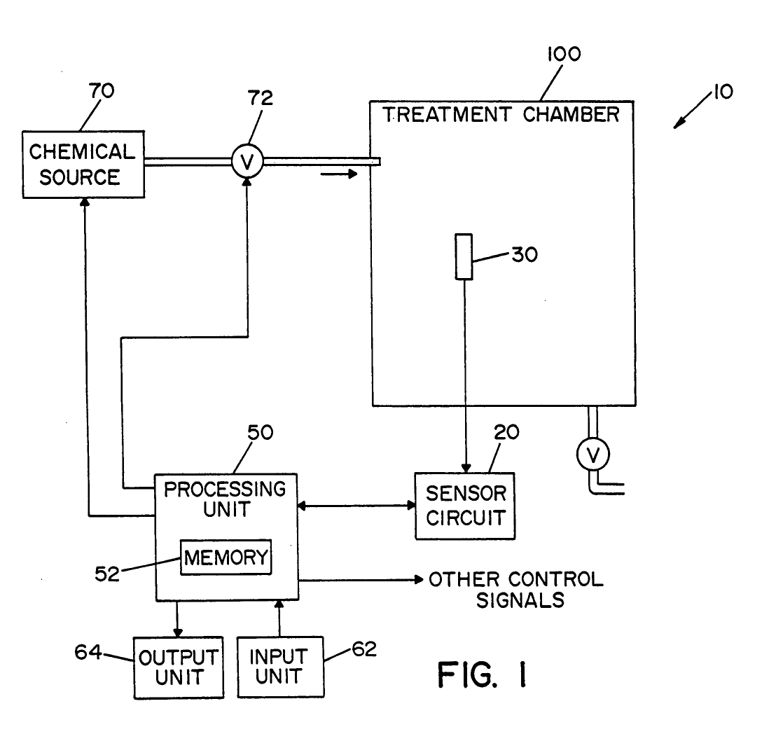

Referring now to the drawings wherein the showings are for the purposes of illustrating a preferred embodiment of the invention only and not for purposes of limiting same, FIG. 1 shows a contamination deactivating system 10, according to a preferred embodiment of the present invention. Deactivating system 10 is generally comprised of a sensor circuit 20, a processing unit 50, a chemical source 70, and a chamber 100.

Sensor circuit 20 includes a sensing element 30 comprising an electroactive material responsive to the concentration of a chemical component inside chamber 100, as will be described in detail below. It should be understood that the chemical component may take the form of a liquid, gas, or combination thereof, wherein “gases” include (a) “gaseous” chemical components that are gases at room temperature, and (b) “vaporous” chemical components that are in a vapor phase due to vaporization of a fluid. Furthermore, it should be appreciated that sensing element 30 may also be responsive to a gaseous or vaporous chemical component (e.g., a sterilant) that is present in a liquid in the chamber 100.

Chemical source 70 includes one or more sources of chemical components that are to be introduced into chamber 100. For example, chemical source 70 may include a vaporization chamber for producing vaporized hydrogen peroxide from liquid hydrogen peroxide. The chemical components may be in the form of a liquid, gas, or combinations thereof. By way of example and not limitation, chemical components may include “deactivating chemicals” (i.e., chemicals for deactivating biocontamination), as well as “base chemicals” and “pre-treatment chemicals.” Base chemicals act as a diluent for a deactivating chemical, or as a vehicle or a carrier for a deactivating chemical. The base chemical may itself be a deactivating chemical or have deactivating properties. Pre-treatment chemicals include chemicals that make a biocontamination more susceptible to deactivation by a deactivating chemical. In the case of prions, pre-treatment chemicals may operate to change a conformational state of the prions, making the prions more susceptible to deactivation.

Flow control 72 may be comprised of one or more valves, flowmeters, and the like, for controlling the release of chemical components from chemical source 70 into chamber 100.

In a preferred embodiment, processing unit 50 communicates with sensor circuit 20 and flow control 72. Processing unit 50 may also generate control signals for the operation of other system elements, such as control means (not shown) for controlling the production of a gas (e.g., a vaporization system) at chemical source 70. Processing unit 50 may also transmit signals to an output unit 64 to provide operator information in an audible and/or visual form. Accordingly, output unit 64 may take the form of an audio speaker and/or visual display unit. Input unit 62 provides a means for entering information into processing unit 50. In this regard, input unit 64 may take the form of a keyboard, keypad, touchscreen, switches, and the like. In a preferred embodiment, processing unit 50 takes the form of a microcomputer or microcontroller, including a memory 52 for data storage. Memory 52 may include data storage devices, including but not limited to, RAM, ROM, hard disk drive, optical disk drive (e.g., Compact Disk drive or DVD drive), and the like.

In general, the present invention is directed to a sensor including a “host” material that has at least one electrical property that is dependent upon the concentration of a dopant, wherein the dopant reacts with a chemical (e.g., a deactivating chemical, such as a sterilant or an oxidant). It will be appreciated that such a chemical could also react with the host material thus effecting a change in the electrical property of the system, i.e., host material and dopant. In accordance with one embodiment of the present invention, at least a portion of the host material includes an amorphous region. Examples of such host materials, without limitation, include glasses and polymers.

It should be understood that the electrical property may include, but is not limited to, resistance, resistivity, conductance, conductivity, voltage, current, etc. The electrical property of the host material will respond to exposure to the chemical with a change in the electrical property of the host material, as a result of the dopant reacting with the chemical. In this respect, the concentration of the dopant is suppressed by the reaction with the chemical. The electrical properties of the host material can thus be used to provide an indication of the concentration of the chemical, as will be explained in detail below.

In accordance with a first embodiment of the present invention, sensing element 30 takes the form of a conducting or electroactive polymer. It has been recognized that electroactive polymers are made electrically conductive by forming charge transfer complexes with either electron donors or electron acceptors. In this regard, electroactive polymers are “doped” to change their electrical properties, i.e., attain high electrical conductivity.

In accordance with a first embodiment of the present invention, the electroactive polymer is polyacetylene, and the dopant is iodide ions. It should be appreciated that polyacetylene and iodide ions are disclosed herein as a preferred electroactive polymer and a preferred dopant; however, it is contemplated that other electroactive polymers (including other electroactive polymers whose electrical conductivity increases when doped with iodide ions) and other dopants are also suitable for use in connection with the present invention.

When the doped polyacetylene is exposed to vaporized hydrogen peroxide, the vaporized hydrogen peroxide reacts with the iodide ions to form triodide ions (doping redox reactions), thus changing the electrical conductivity of the polyacetylene. In this regard, as the concentration of the dopant is suppressed due to reaction with the vaporized hydrogen peroxide, the electrical properties of the polyacetylene will change. The change in the electrical properties provides a measure that can be correlated to the concentration of vaporized hydrogen peroxide. The change in electrical conductivity is proportional to the concentration of vaporized hydrogen peroxide.

As indicated above, the electrical conductivity of sensing element 30 will change as the doped polyacetylene is exposed to vaporized hydrogen peroxide. In this regard, as the iodide ions of the doped polyacetylene are exposed to a uniform concentration of vaporized hydrogen peroxide, the electrical conductivity of sensing element 30 will change in time (as the vaporized hydrogen peroxide reacts with the iodide ions to form triodide ions). A curve relating electrical conductivity of sensing element 30 as a function of time can be developed. The slope of this curve is indicative of a concentration of vaporized hydrogen peroxide in chamber 100. A plurality of data sets representative of curves for different concentrations of vaporized hydrogen peroxide, and/or their corresponding slopes are stored in memory 52. Each curve will have a different corresponding slope. To determine an unknown concentration of vaporized hydrogen peroxide in chamber 100, data is collected using sensor circuit 20 to develop a curve and determine its slope. This slope is then compared to pre-stored slopes of curves corresponding to known concentrations of vaporized hydrogen peroxide in chamber 100. Accordingly, a comparison with the pre-stored slopes can be used to determine the unknown concentration of the vaporized hydrogen peroxide.

If the concentration of the vaporized hydrogen peroxide in chamber 100 changes, the corresponding slope of the electrical conductivity versus time curve will change. By monitoring the change in the slope of the curve, feedback loops can be used to operate and maintain a steady uniform concentration (i.e., above a “kill” concentration) of vaporized hydrogen peroxide in chamber 100.

It should be appreciated that the data sets representative of electrical conductivity versus time curves may be interpolated or extrapolated to obtain a slope representative of a concentration.

In accordance with a second embodiment of the present invention, pitch-based carbon/graphite fibers are exposed to molecular bromine to form an intercalcated carbon/graphite fiber. In this regard, the bromine molecules intercalate the carbon fibers, i.e., the molecules of bromine slip in between the graphene planes and remain trapped there.

The electrical conductivity of a material is determined by: (1) the charge mobility, i.e., the ease at which electrical charges move through the material, and (2) the concentration of charge carriers. In this respect, the graphene planes have a high charge mobility, i.e., within the graphene planes. However, the concentration of charge carriers is low, thus resulting in an electrical conductivity of pristine carbon/graphite fibers comparable to that of a semiconductor. Intercalation with bromine molecules results in increased electrical conductivity of the pristine carbon/graphite fibers, as holes are donated to the graphene planes by the molecular bromine molecules. It has been observed that electrical conductivities can be boosted by orders of magnitude when pitch-based carbon/graphite fibers are intercalated with molecular bromine. Brominated, pitch-based carbon/graphite fibers are stable and can carry electrical currents for very long periods of time without any measurable decrease in electrical conductivity.

In accordance the second embodiment of the present invention, sensing element 30 takes the form of a brominated pitch-based carbon/graphite fiber. Sensing element 30 is exposed to a concentration of vaporized hydrogen peroxide in chamber 100. The vaporized hydrogen peroxide reacts with the molecular bromine to produce hydrogen bromide and molecular oxygen. The chemical reaction between the vaporized hydrogen peroxide and the molecular bromine may be further driven by Joule heat. In this regard, the pitch-based carbon/graphite fiber is heated by passing an electrical current therethrough. An increase in the electrical current results in an increase in the heat for driving the chemical reaction.

It is necessary to pass an electrical current through the pitch-based carbon/graphite fiber in order to measure electrical properties of the pitch-based carbon/graphite fiber. Accordingly, this electrical current serves two functions for sensor circuit 20. First, it provides Joule heat to drive the molecular bromine/hydrogen peroxide chemical reaction within the pitch-based carbon/graphite fiber. Second, it provides the electrical current needed to measure the electrical properties of the intercalated, pitch-based carbon/graphite fiber, and thus determine the concentration of the vaporized hydrogen peroxide.

As the bromine reacts with the hydrogen of the hydrogen peroxide molecule, the concentration of the intercalated bromine decreases, resulting in a loss of charge carriers and a decrease in the electrical conductivity of the pitch-based carbon/graphite fibers.

The electrical conductivity of sensing element 30 will change as the pitch-based carbon/graphite fiber is exposed to vaporized hydrogen peroxide. As the pitch-based carbon/graphite fiber is exposed to a uniform concentration of vaporized hydrogen peroxide, the electrical conductivity of sensing element 30 will change in time (as the vaporized hydrogen peroxide reacts with the bromine molecules). As described above, a curve relating electrical conductivity of sensing element 30 as a function of time can be developed. The slope of this curve is indicative of a concentration of vaporized hydrogen peroxide in chamber 100. A plurality of data sets representative of curves for different concentrations of vaporized hydrogen peroxide, and/or their corresponding slopes are stored in memory 52, wherein each curve has a different corresponding slope.

In the same manner as described above in connection with the first embodiment, an unknown concentration of vaporized hydrogen peroxide in chamber 100 is determined by collecting data using sensor circuit 20 to develop a curve and determine its slope. This slope is then compared to pre-stored slopes of curves corresponding to known concentrations of vaporized hydrogen peroxide in chamber 100. Accordingly, a comparison with the pre-stored slopes can be used to determine the unknown concentration of the vaporized hydrogen peroxide. If the concentration of the vaporized hydrogen peroxide in chamber 100 changes, the corresponding slope of the electrical conductivity versus time curve will change. By monitoring the change in the slope of the curve, feedback loops can be used to operate and maintain a steady uniform concentration (i.e., above a “kill” concentration) of vaporized hydrogen peroxide in chamber 100.

Sensor circuit 20 may take the form of a wide variety of suitable circuits that utilize an electrical property of sensing element 30 that is responsive to the concentration of a chemical component. In a preferred embodiment of the present invention, the chemical component is vaporized hydrogen peroxide. It should be appreciated that the sensor circuits disclosed herein are exemplary only, and are not intended in any way to be a limitation to the breadth of sensor circuits contemplated for use in connection with the present invention.

Sensor circuit 20 provides data indicative of the conductance of sensing element 30. The conductance of sensing element 30 will vary in accordance with changes in the concentration of chemical components inside chamber 100. Conductivity is a measure of conductance per unit length.

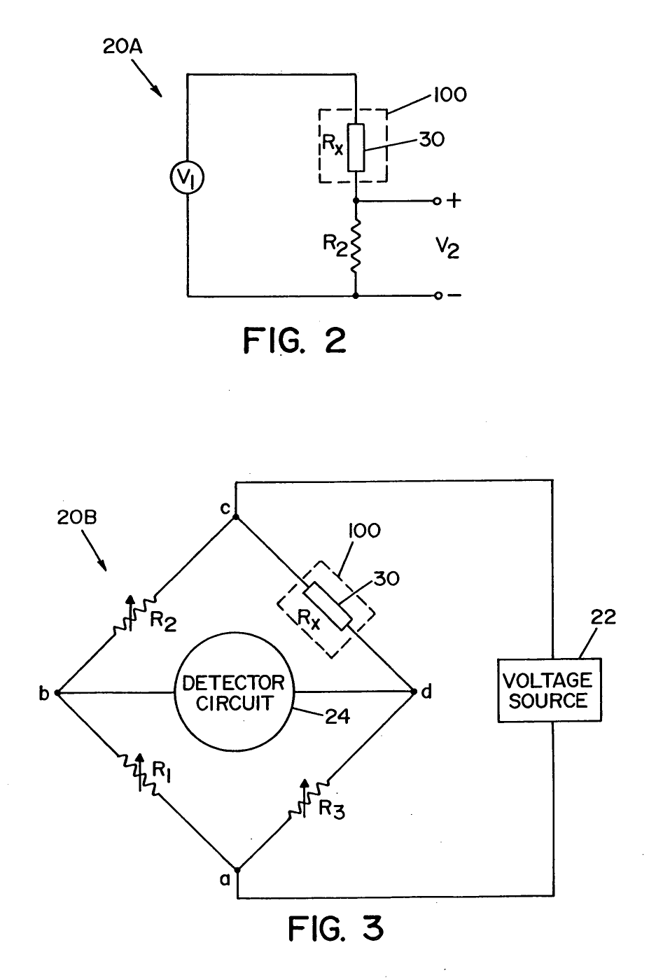

Referring now to FIG. 2, there is shown a detailed schematic of a first exemplary sensor circuit 20A. Sensor circuit 20A takes the form of a voltage divider generally comprised of a voltage source having a voltage V₁, a resistor having a known resistance R₂, and sensing element 30 having a resistance Rₓ (and conductance Gₓ). Sensing element 30 is exposed to chemical components inside chamber 100.

As is well known to those skilled in the art, the voltage divider of sensor circuit 20A relates voltage and resistance in accordance with the following relationship:

$${V}_{2} = ( \frac{{R}_{2}}{{R}_{x} + {R}_{2}} ) {V}_{1} ,$$

where Rₓ is the resistance of sensing element 30. Since, conductance (G) is the reciprocal of resistance (R),

$${V}_{2} = ( \frac{1}{{R}_{x} {G}_{2} + 1} ) {V}_{1} ,$$

where Gₓ is the conductance of sensing element 30. Therefore, as the conductance of sensing element 30 decreases, voltage V₂ will increase.

Referring now to FIG. 3, there is shown a detailed schematic of a second exemplary sensor circuit 20B. Sensor circuit 20B takes the form of a “bridge circuit.” As is well known to those skilled in the art, bridge circuits are used to deternine the value of an unknown impedance in terms of other impedances of known value. Highly accurate measurements are possible because a null condition is used to determine the unknown impedance. The bridge circuit is used to determine a resistance (or conductance) value indicative of the concentration of chemical components in chamber 100.

In the embodiment shown, the bridge circuit takes the form of a “Wheatstone bridge,” well known to those skilled in the art. Accordingly, sensor circuit 20 is generally comprised of a voltage source 22, a detector circuit 24 for detecting a null condition, variable resistors having respective resistance values R₁, R₂ and R₃, a sensing element 30 having a resistance Rₓ. Sensing element 30 is exposed to chemical components inside chamber 100.

Variable resistors having resistance values of R₁, R₂ and R₃ preferably take the form of electronic potentiometers that function in the same manner as a mechanical potentiometer. An electronic potentiometer is a three terminal device. Between two of the terminals is a resistive element. The third terminal known as the “wiper” is connected to various points along the resistive element. The wiper is digitally controlled by processing unit 50 (see FIG. 1). The wiper divides the resistive element into two resistors. The electronic potentiometer may take the form of a digitally programmable potentiometer (DPPTM) available from Catalyst Semiconductor, Inc. of Sunnyvale, Calif.

In a preferred embodiment, voltage source 22 provides a DC voltage. Detector circuit 24 detects a null condition (i.e., a short circuit), and may take the form of such devices as a galvanometer, a voltmeter, a frequency-selective amplifier, and the like.

As is well known to those skilled in the art, when a null condition (i.e., no difference of potential between points b and d) is detected by detector circuit 24, the relationship among the resistances R₁, R₂, R₃ and Rₓ, are as follows:

$$\frac{{R}_{1}}{{R}_{2}} = \frac{{R}_{3}}{{R}_{x}} , \\ {R}_{x} = \frac{{R}_{3} {R}_{2}}{{R}_{1}} , and$$

$${G}_{x} = \frac{{R}_{1}}{{R}_{3} {R}_{2}} .$$

Therefore, a measurement of R₁, R₂ and R₃ will provide a measure of conductance Gₓ of sensing element 30.

It should be appreciated that while a preferred embodiment of the present invention has been described with reference to sensing a concentration of vaporized hydrogen peroxide, it is contemplated that the present invention finds utility in sensing a concentration of other chemical components. These chemical components may comprise deactivating chemicals, including, but not limited to, chemicals selected from the group consisting of: hypochlorites, iodophors, quaternary ammonium chlorides (Quats), acid sanitizers, aldehydes (formaldehyde and glutaraldehyde), alcohols, phenolics, peracetic acid (PAA), and chlorine dioxide.

Specific examples of deactivating chemicals, include, but are not limited to, liquid hydrogen peroxide, peracids such as peracetic acid, bleach, ammonia, ethylene oxide, fluorine containing chemicals, chlorine containing chemicals, bromine containing chemicals, vaporized hydrogen peroxide, vaporized bleach, vaporized peracid, vaporized peracetic acid, ozone, ethylene oxide, chlorine dioxide, halogen containing compounds, other highly oxidative chemicals (i.e., oxidants), and mixtures thereof.

As indicated above, the chemical components introduced into chamber 100 may also include base chemicals. Examples of base chemicals, include, but are not limited to, water, de-ionized water, distilled water, an alcohol (e.g., a tertiary alcohol), a glycol-containing chemical compound, and mixtures thereof. Glycol-containing chemical compounds include, but are not limited to, polyethylene glycol, diethylene glycol, triethylene glycol, tetraethylene glycol, glycol ethers, polypropylene glycol, propylene glycol, de-ionized water vapor, distilled water vapor, a vaporized alcohol (e.g., a tertiary alcohol), and mixtures thereof. As indicated above, the base chemical may itself be a deactivating chemical. Therefore, the base chemical may also be any one of the deactivating chemicals listed above.

Some typical combinations of a deactivating chemical and a base chemical, include, but are not limited to, hydrogen peroxide and water, bleach and water, peracid and water, peracetic acid and water, alcohol and water, and ozone dissolved in a glycol, an alcohol (e.g., tertiary alcohol), or water. Some examples of gaseous atmospheres that may be created inside chamber 100, include, but are not limited to: ozone; vaporized hydrogen peroxide and water vapor; ethylene oxide; vaporized hydrogen peroxide, water vapor and ozone; vaporized hydrogen peroxide, water vapor and ethylene oxide; ozone and ethylene oxide; and vaporized hydrogen peroxide, water vapor, ozone and ethylene oxide.

Other modifications and alterations will occur to others upon their reading and understanding of the specification. It is intended that all such modifications and alterations be included insofar as they come within the scope of the invention as claimed or the equivalents thereof.

1. A sensor for the detection of a concentration of a chemical component, comprising:
a host material;
an additive that modifies an electrical property of the host material, the additive having a chemical reaction when exposed to the chemical component;
a source of electrical current, said electrical current conducting through the host material; and
means for measuring a change in the electrical property of the host material as the chemical component reacts with the additive.

2. A sensor according to claim 1, wherein said chemical reaction having a reaction rate that is a function of the heat generated by said electrical current, as said electrical current conducts through said host material.

3. A sensor according to claim 1, wherein said chemical component is selected from the group consisting of: a gas and a liquid.

4. A sensor according to claim 1, wherein said chemical component is selected from the group consisting of: a gaseous or a vaporous sterilant, and a liquid sterilant.

5. A sensor according to claim 1, wherein said chemical component is selected from the group consisting of: hypochlorites, iodophors, quaternary ammonium chlorides (Quats), acid sanitizers, aldehydes (formaldehyde and glutaraldehyde), alcohols, phenolics, peracetic acid (PAA), chlorine dioxide, and mixtures thereof.

6. A sensor according to claim 1, wherein said chemical component is selected from the group consisting of: vaporized hydrogen peroxide, vaporized bleach, vaporized peracid, vaporized peracetic acid, ozone, ethylene oxide, chlorine dioxide, halogen containing compounds, and mixtures thereof.

7. A sensor according to claim 6, wherein said halogen containing compound includes a halogen selected from the group consisting of: chlorine, fluorine and bromine.

8. A sensor according to claim 1, wherein said chemical component is selected from the group consisting of: liquid hydrogen peroxide, a peracid, bleach, ammonia, ethylene oxide, fluorine containing chemicals, chlorine containing chemicals, bromine containing chemicals, and mixtures thereof.

9. A sensor according to claim 1, wherein said host material is an electroactive material.

10. A sensor according to claim 9, wherein said electroactive material includes an electroactive polymer.

11. A sensor according to claim 10, wherein said electroactive polymer is polyacetylene.

12. A sensor according to claim 1, wherein said additive includes a dopant reactive with the chemical component.

13. A sensor according to claim 12, wherein said dopant is iodine.

14. A sensor according to claim 1, wherein said host material includes pitch-based carbon/graphite fibers.

15. A sensor according to claim 1, wherein said additive includes bromine molecules.

16. A sensor according to claim 1, wherein said source of electrical current increases the temperature of the host material.

17. A sensor according to claim 1, wherein said sensor further comprises:
memory means for storing a plurality of data sets in a memory, wherein said data sets includes a value indicative of said electrical property as a function of time exposure to the chemical component.

18. A sensor according to claim 17, wherein said value is a slope.

19. A sensor according to claim 17, wherein said sensor further comprises:
means for interpolating or extrapolating data from the plurality of data sets stored in said memory means.

20. A sensor according to claim 1, wherein at least a portion of said host material includes an amorphous region.
